(19) United States
(12) Patent Application Publication
(10) Pub. No.: US 2008/0016618 A1
(43) Pub. Date: Jan. 24, 2008

(54) Patient Handling and Transfer Device

(76) Inventors: Louise Ann O'Shea, Beaumaris (AU); Aidan Searle, Heathmont (AU)

Correspondence Address: COHEN & GRIGSBY, P.C., 11 STANWIX STREET, 15TH FLOOR, PITTSBURGH, PA, 15222, US

(21) Appl. No.: 11/779,966

(22) Filed: Jul. 19, 2007

Related U.S. Application Data
(60) Provisional application No. 60/807,945, filed on Jul. 21, 2006.

(51) Int. Cl. A61G 7/10

(52) U.S. Cl. 5/81.1 T; 5/81.1 R

(57) ABSTRACT

A patient handling device suitable for transferring a patient from one surface to another and for repositioning on the bed, the device includes a generally planar rectangular sheet and mattress retainers that resist longitudinal and lateral movement of the rectangular sheet.

### CROSS REFERENCE TO RELATED APPLICATION

The present application claims priority to U.S. Provisional Application No. 60/807,945 filed Jul. 21, 2006.

### FIELD OF THE INVENTION

Embodiments of the invention relates to a patient handling device, particularly a patient handling device suitable for repositioning a patient on the bed, moving the patient up the bed and laterally transferring a patient from one surface to another, including from a bed to a trolley.

### BACKGROUND OF THE INVENTION

In this specification where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

Patients in hospitals, hospices, aged care facilities and the like may be incapacitated and have limited movement due to age or infirmity. Carers such as nurses, physiotherapists, personal care attendants and other health professionals are often required to assist with movement of patients between beds, trolleys, operating tables and with repositioning on the bed. The majority of workplace injury claims in the health care and aged care industries are for musculoskeletal injuries. Most of these are related to high risk manual handling tasks such as lifting, moving and repositioning patients.

Accordingly, a wide range of products (called patient handling devices) are marketed for lifting and moving patients. The wide range is necessary to address the varied needs of carers and patients, and other considerations such as compatibility with existing layout, durability, and how easily the product can be used, maintained, cleaned and disinfected.

Mechanical lifting equipment such as mobile hoists or overhead track hoists are extremely efficient and highly preferred for moving dependent patients from bed to chair to bed, off the floor or from chair to chair.

Sliding boards or slideboards are large reinforced boards of various sizes. They are used in conjunction with slippery sheets, to decrease the frictional forces during transfer of a patient between a trolley and a bed and can be used to bridge the gap between them. Typically slideboards are used to transfer unconscious patients or patients who are unable to sit up or assist in transferring. Slideboards typically have cut out handles along their sides so they can be moved easily. The slideboard is placed underneath the slide sheet on a mattress. The patient is rolled onto their side and a slide sheet is positioned under the patient. The slide board is then positioned under the slide sheet and partially under the patient. The patient is then slid across from one bed or trolley to another, with carers pushing the patient on one side and pulling the slide sheet on the other. The slide sheet slides across on the slippery surface of the slideboard. The board is removed from under the patient after the transfer.

Sliding boards are large and unwieldy and require a team of experienced carers, usually a minimum of two carers, or ideally three to four carers. Furthermore, boards can only be used when the two surfaces (e.g., two beds or bed/trolley) are of similar height or can be adjusted to similar heights. Furthermore, the carers on the pulling side of the sliding board have to stretch forward in order to hold the slide sheet. The carers on the other side push the patient at the hip and shoulder. The weight of the patient increases the force needed to move the patient. The weight of the patient and the forward flexion increases the risk of musculoskeletal injury for the carer due to the significant weight of the load, the load is a considerable distance from the spine and the risk of injury increases with the width of the bed. Also, patients still have to be lifted and rolled slightly so that the board can be placed underneath them and subsequently removed.

A variation on the slide board is the roller board, comprising a fabric tube around a board, but these are often uncomfortable for all but the smallest patients and again there is an issue with staff adopting awkward postures such as forward flexion and push/pulling a significant load. A further issue with the use of slide boards is around the cleaning of the fabric covering and the associated infection control issues.

Slide sheets comprise a rectangle of thin, slippery material that is either folded in half or two sheets are placed under the patient. The top layer slides on the bottom layer reducing friction significantly. When it is positioned under a patient, a slide sheet can be used to assist in rolling them over or repositioning them on a bed. Long slide sheets are also used for bed to bed transfer. However, they can be unpredictably slippery. Once a patient slips against the slide sheet, or the slide sheet slips against a mattress surface, the momentum can be difficult to stop. The effectiveness of the slide sheet is also affected if the slide sheet becomes wet, if a large patient is required to be moved or the sheet's slipperiness declines due to laundering. The use of Velcro retainers to resist sliding has proved unpopular because the Velcro® hook and loop material traps dirt and is extremely difficult to disinfect. Slide sheets are also difficult to position under a patient without extensively handling and rolling the patient. Furthermore, some slide sheets include handles, but these are not always located in the convenient positions, thus limiting optimized placement of the carer's hands and increasing the carer's reach distance.

The ErgoSlide® lateral transfer device sold by Ergosafe Products, LLC is a type of slide sheet that incorporates a number of webbing loops along the two longest edges of a rectangular piece of fabric. In use the carer puts their hands (palms upward) through the loops in an appropriate position to roll or slide the patient as appropriate. However this type of slide sheet is only useful for repositioning a patient on a bed, not for transferring them from one bed to another.

The Phil-E-Slide lateral transfer aid sold by Phil-E-Slide Inc. is a thin bed sized flexible quilted patient pad which lies on top on attached or detachable roller sheet of the same dimensions. It is used for patient transfer in a lying position from bed to bed or for patient turning. The product has long detachable pull straps which provide arm extensions without compromising the carer's posture during patient transfers. Bridger slats can be inserted into integral pockets to make the quilted pad semi rigid for transfer of patients across small gaps.

There is a need therefore for a device for patient transfer that improves patient comfort while minimizing physical stress on carers. There is also a need for a device that minimizes or avoids patient discomfort caused when a transfer device is located under the patient, or when the device is used for patient transfer.

### SUMMARY OF THE INVENTION

Embodiments of the present invention provide a patient handling device suitable for transferring a patient from one surface to another and for repositioning on the bed. The device includes a generally planar rectangular sheet and mattress retainers that resist longitudinal and lateral movement of the rectangular sheet.

More specifically, in a preferred embodiment the present invention provides a patient handling device suitable for transferring a patient from one surface to another, and for repositioning on the bed. The device comprises:
a generally planar rectangular sheet having an upper surface and a lower surface, the lower surface having a larger slip coefficient relative to the upper surface, and
one or more mattress retainers for resisting longitudinal or lateral movement of the rectangular sheet relative to the mattress,
wherein in use, a patient is located adjacent the upper surface of the rectangular sheet and the lower surface is located adjacent the upper surface of a mattress,
and wherein upon manual removal of the one or more mattress retainers from the mattress, the patient may be supported on the rectangular sheet and manually transferred from the upper surface of the mattress to another surface or repositioned on the bed.

In a preferred embodiment the one or more mattress retainers comprise straps. The straps may include any convenient length adjustment device such as one or more buckles or Velcro strips intermediate the length of the straps. The straps may also be at least partly elastic along their length or alternatively, inextensible.

In another preferred embodiment the invention includes four mattress retainers, one located at each of the four corners of the planar rectangular sheet. The patient transfer device of the present invention may thus remain with the patient when they are moved between beds or between a bed and another surface such as a trolley. This avoids the problems of the prior art associated with having to excessively handle a patient to appropriately locate (and subsequently remove) a device under their body.

The mattress retainers may optionally be integral with the rectangular sheet.

Preferably the device of the present invention is principally of strong, durable material that is waterproof and readily cleaned. The upper surface of the rectangular sheet or the combined upper and lower surfaces must have sufficient strength to support the weight of a patient when the rectangular sheet is supported by its corners or edges. The lower surface may be comprised of material such as nylon. The use of material gives flexibility to the device and avoids the discomfort or pain inflicted on patients by less flexible devices of the prior art.

In a particularly preferred embodiment the upper surface and lower surface of the sheet together enclose a cushioning material. Preferably the cushioning material is a layer of memory foam such as the foam sold under the Tempur® trade mark, to increase patient comfort and reduce risk of pressure ulcers and shearing. Memory foam is typically too expensive to incorporate into hospital mattresses—they are usually made of far less expensive material such as multilayer foam. The present invention allows the patient to enjoy the benefit and comfort of memory foam without the expense or need for a mattress entirely constructed of this material.

In one preferred embodiment of the present invention, each mattress retainer of the patient transfer device comprises a rectangular pocket that fits over a mattress corner. The high slip coefficient of the lower surface of the sheet would typically cause the device to slide laterally or longitudinally along the surface of the mattress if not for the mattress retainers. Accordingly, if a carer needs to move a patient around on a bed, they need only manually release two or more of the mattress retainers in order to slide the sheet up or down the mattress and re-position the patient.

In another preferred embodiment of the present invention, each mattress retainer of the patient transfer device comprises a strap that anchors the planar, rectangular sheet to the mattress. For example, the strap may be located such that it can be slipped over a corner of the mattress or alternatively located across the width of the mattress.

One of the advantages of the device of the present invention is that it can stay in position on beds that have an adjustable head or foot section. So, for example, the head section of the bed can be jacked up to raise the patient's head and shoulders and the device of the present invention will remain in position and not slide down the bed.

The device of the present invention may include a gripping means at one or more of the longitudinal edges and/or the lateral edges of the rectangular sheet. The gripping means may be integral with longitudinal edges and extend along the entire length of the longitudinal edges.

An embodiment of the present invention further provides a method of transferring a patient from one surface to another surface using the patient handling device, the method comprising the steps of:
(a) manually removing the one or more mattress retainers from a mattress while a patient is in place on the planar rectangular sheet,
(b) supporting the patient on the rectangular sheet,
(c) manually transferring the patient from the upper surface of the mattress to second surface.

When the second surface is a second mattress, the method includes the further step of manually attaching the one or more mattress retainers to the second mattress.

An embodiment of the present invention also provides a method of repositioning a patient on a bed using the patient handling device, the method comprising the steps of:
(a) manually removing the one or more mattress retainers from a mattress while a patient is in place on the planar rectangular sheet,
(b) supporting the patient on the rectangular sheet sufficient to move them relative to the mattress,
(c) manually reattaching the mattress retainers to the mattress.

One of the advantages of using mattress retainers comprising straps is that they provide latitude for repositioning the rectangular sheet relative to the mattress.

### BRIEF DESCRIPTION OF THE DRAWINGS

Various embodiments/aspects of the invention will now be described with reference to the following drawings in which,

FIG. 1 is a drawing of the Pelican brand slide sheet of the prior art;

FIG. 2 is a drawing of the Phil-E-Slide® lateral transfer aid of the prior art;

FIG. 3 is a perspective drawing of one embodiment of the device of the present invention when in place on a mattress;

FIG. 4 is a plan drawing of the embodiment of the device depicted in FIG. 3; and

FIG. 5 is a perspective drawing of a further embodiment of the device of the present invention when in place on a mattress.

### DESCRIPTION

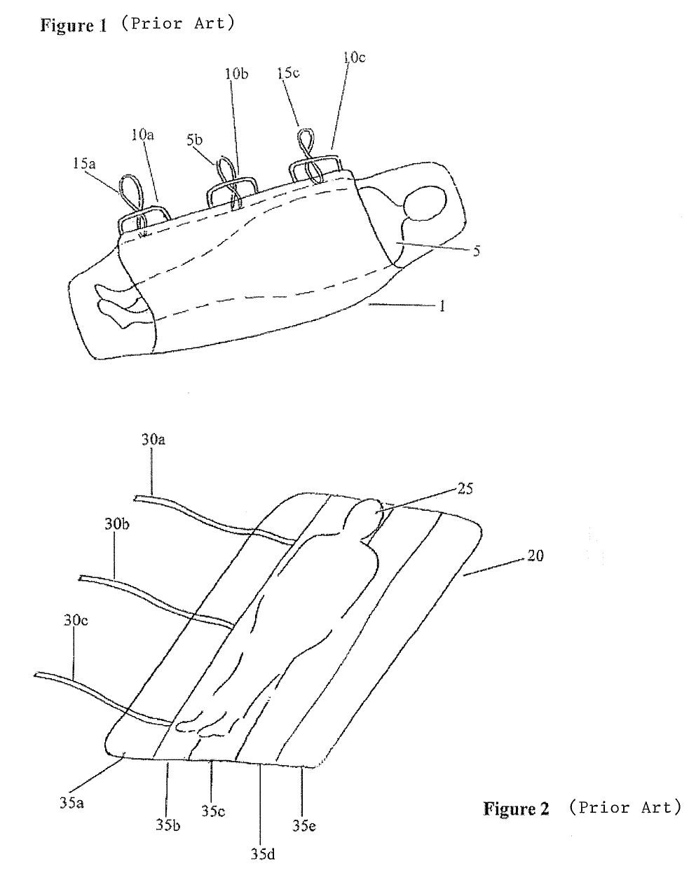

351 FIG. 1 depicts the Pelican slide sheet (1), sold by Pelican Manufacturing Pry Ltd, consisting of a strong nylon sheet. In use the patient (5) must be rolled over so that one half of the slide sheet (1) may be placed underneath them. Typically the draw sheet on the bed is used to pull the slide sheet (1) under the patient. The free half of the slide sheet (1) is then folded over the patient (5) so they are wrapped in the slide sheet (1). The loop straps (10a, 10b, 10c) located on one edge of the slide sheet (1) are placed over pulling handles (15a, 15b, 15c) located on the other edge of the slide sheet (1). The pulling handles (15a, 15b, 15c) are long enough for the carer to reach when standing with transfer bed/trolley in position next to the bed. This type of transfer device is typically used in conjunction with a slide board which is put in place partly under the patient and partly over the edge of the bed ready to lay on the transfer bed/trolley once it is in position alongside the bed. Depending on the patient's weight one, two or three nurses can pull the patient across to the transfer bed/trolley using the padded handles (15a, 15b, 15c). Once the patient is on the transfer bed/trolley, they must be rolled to remove the slide sheet (1).

FIG. 2 depicts the Phil-E-Slide® lateral transfer aid (20) which consists of a thin bed sized flexible quilted pad which can be positioned intermediate a patient (25) and a detachable roller sheet of the same dimensions. The transfer aid (20) has long detachable pull straps (30a, 30b, 30c) which provide arm extensions without compromising the carer's posture during patient transfers. Bridger slats can be inserted into integral pockets (35a to 35e) to make the quilted pad semi rigid for transfer of patients across small gaps.

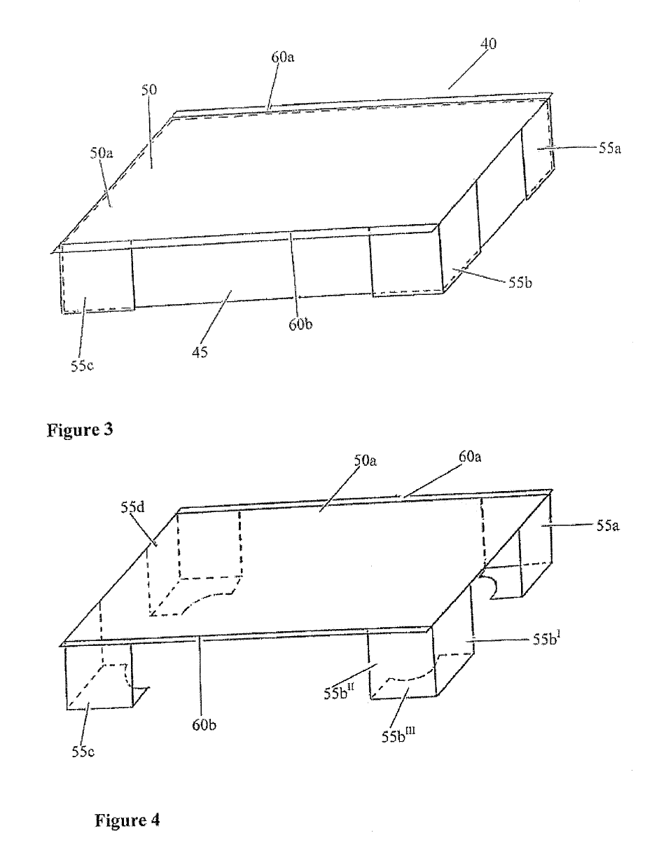

FIG. 3 depicts one embodiment of the patient handling device (40) of the present invention located on a mattress (45). The device (40) includes a generally planar rectangular sheet (50) having an upper surface (50a) and a lower surface (not visible). The lower surface is located adjacent the upper surface of the mattress (45). The four mattress retainers (55a, 55b, 55c) (55d not visible in FIG. 3) are each located at a corner of the planar rectangular sheet (50). In this embodiment, each mattress retainer (55a, 55b, 55c, 55d) is of generally rectangular or ‘box’ shape such that it snugly fits the corner and resists lateral or longitudinal movement of the sheet (50) against the mattress (45). This embodiment includes two gripping devices (60a, 60b) extending along the entire length of the two longitudinal edges of the rectangular sheet (50).

FIG. 4 depicts a plan view of the embodiment of the patient handling device (40) shown in FIG. 3, removed from the mattress. In this view the planar rectangular sheet (50) having an upper surface (50a), two gripping devices (60a, 60b) and the four mattress retainers (55a, 55b, 55c, 55d) are clearly visible. In this embodiment each mattress retainer (55a, 55b, 55c, 55d) is of generally rectangular or ‘box’ shape, having two sides (55b′, 55b″) and a flat base (55b′″). The flat base may be rectangular, or, as in this embodiment, may be generally L-shaped. The upper surface (50a), gripping devices (60a, 60b) and the two sides of each of the four mattress retainers (55a, 55b, 55c, 55d) are of the same material. The base of each mattress retainer (55a, 55b, 55c, 55d) may be of different or same material, strengthened to make it rigid and therefore easier to position under the corner of a mattress.

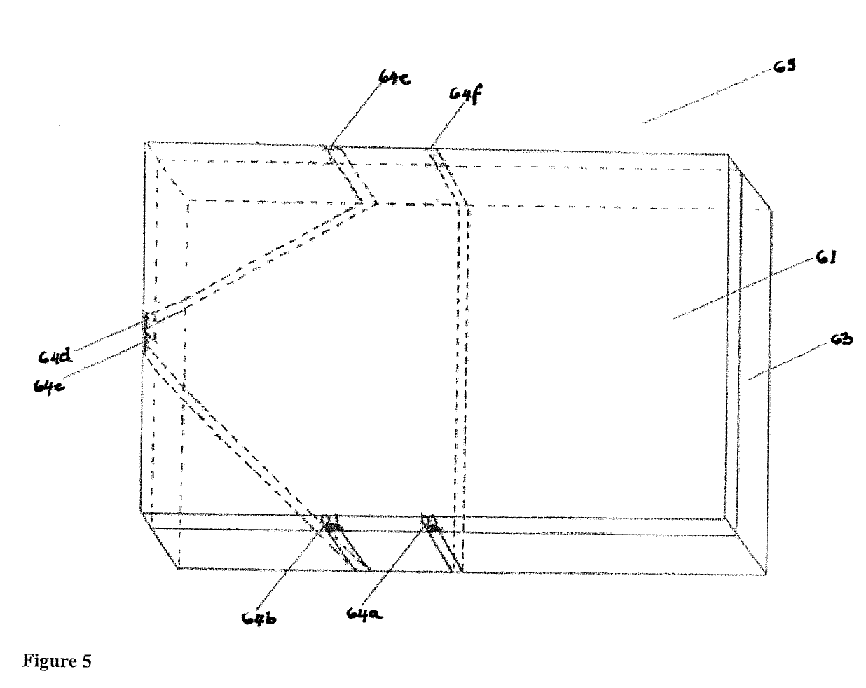

FIG. 5 depicts a further embodiment of the patient handling device (65) of the present invention located on a mattress (63). The device (65) includes a generally planar rectangular sheet (61) having an upper surface and a lower surface. The lower surface is located adjacent the upper surface of the mattress (61). The three mattress retainers (62a, 62b, 62c) consist of elongated straps with buckle attachments (64a-64f) for facilitating location of the rectangular sheet (61) on the mattress (63).

The word ‘comprising’ and forms of the word ‘comprising’ as used in this description and in the claims does not limit the invention claimed to exclude any variants or additions.

Modifications and improvements to the invention will be readily apparent to those skilled in the art. Such modifications and improvements are intended to be within the scope of this invention.

What is claimed is:

1. A patient handling device suitable for transferring a patient from one surface to another and for repositioning on a bed, the device comprising: a generally planar rectangular sheet; and one or more mattress retainers that resist longitudinal and lateral movement of the rectangular sheet.

2. A patient handling device suitable for transferring a patient from one surface to another, and for repositioning on the bed, the device comprising:
(a) a generally planar rectangular sheet having an upper surface and a lower surface, the lower surface having a larger slip coefficient relative to the upper surface, and
(b) one or more mattress retainers for resisting longitudinal or lateral movement of the rectangular sheet relative to the mattress,
wherein in use, a patient is located adjacent the upper surface of the rectangular sheet and the lower surface is located adjacent the upper surface of a mattress,
and wherein upon manual removal of the one or more mattress retainers from the mattress, the patient may be supported on the rectangular sheet and manually transferred from the upper surface of the mattress to another surface or repositioned on the bed.

3. A patient handling device according to claim 1 wherein the one or more mattress retainers comprise straps.

4. A patient handling device according to claim 1 wherein the one or more mattress retainers comprise a rectangular pocket adapted to fit over a mattress corner.

5. A patient handling device according to any one of the preceding claims wherein the one or more mattress retainers are removably located at the four corners of the planar rectangular sheet.

6. A patient handling device according to claim 2 wherein the patient handling device is made of waterproof material, the upper surface of the rectangular sheet having sufficient strength to support the weight of a patient when the rectangular sheet is supported by its corners or edges.

7. A patient handling device according to claim 2 wherein the lower surface is comprised of a synthetic material.

8. A patient handling device according to claim 2 wherein the upper surface and lower surface of the sheet enclose a cushioning material.

9. A patient handling device according to claim 8 wherein the cushioning material is a layer of memory foam.

10. A patient handling device according to claim 1 wherein each of the one or more mattress retainers comprises a rectangular pocket that fits over a mattress corner.

11. A patient handling device according to claim 1 which further includes a means for manual gripping one or more of the longitudinal edges or the lateral edges of the rectangular sheet.

12. A method of transferring a patient from one surface to another surface using a patient handling device, the method comprising the steps of:
(a) manually removing one or more mattress retainers that resist longitudinal and lateral movement of a planar rectangular sheet from a mattress while a patient is in place on the planar rectangular sheet,
(b) supporting the patient on the rectangular sheet,
(c) manually transferring the patient from an upper surface of the mattress to a second surface.

13. A method according to claim 12 wherein when the second surface is a second mattress, the method including the further step of manually attaching the one or more mattress retainers to the second mattress.

14. A method of repositioning a patient on a bed using a patient handling device, the method comprising the steps of:
(a) manually removing one or more mattress retainers that resist longitudinal and lateral movement of a planar rectangular sheet from a mattress while a patient is in place on the planar rectangular sheet,
(b) supporting the patient on the rectangular sheet sufficient to move them relative to the mattress,
(c) manually reattaching the mattress retainers to the mattress.
